(19) United States
(12) Patent Application Publication
(10) Pub. No.: US 2017/0333798 A1
(43) Pub. Date: Nov. 23, 2017

(54) EASY CHAIR DRIVERS SEAT

(71) Applicant: John Erik Hnida, Williamsfield, OH (US)

(72) Inventor: John Erik Hnida, Williamsfield, OH (US)

(21) Appl. No.: 15/597,744

(22) Filed: May 17, 2017

Related U.S. Application Data
(60) Provisional application No. 62/337,662, filed on May 17, 2016.

(51) Int. Cl. A63F 13/98; A63F 13/245; A63F 13/803

(52) U.S. Cl. CPC A63F 13/98; A63F 13/803; A63F 13/245; A63F 2300/8017; A63F 2300/1062

(57) ABSTRACT

A video gaming station for mounting a game controller that enables the player to comfortably sit in a home furnishing, such as a couch or an easy chair, while playing a game. The game controller is preferably a steering wheel or yoke type controller, such as used in motor vehicle racing games. The controller mounting station is configured to position the game controller at an ergonomic position and provides the player the comfort and seating more like that of a driver's seat in a motor vehicle.

### CROSS-REFERENCE TO RELATED APPLICATION

This application claims the benefit of priority of U.S. provisional application No. 62/337,662, filed May 17, 2016, the contents of which are herein incorporated by reference.

### BACKGROUND OF THE INVENTION

The present invention relates to video game controller stations and, more particularly, to video game controller stations for driving simulation play.

Video gaming steering wheel controllers can be difficult to stabilize using conventional means. Such controllers are typically clamped to a table, fixed to a separate bracket, or held on the lap, which diminishes the user's experience while playing driving/racing games and simulators.

Other devices that hold video gaming steering wheel controllers allow the wheel and controller to move around during operation, which diminishes the driving experience. Moreover, the placement of these controllers do not provide a comfortable operator's seat while engaged in game play.

As can be seen, there is a need for an improved driver station for video game controllers that provides a secure mount for the controller, while providing a more comfortable seating arrangement for the operator interacting with video gaming steering wheel controller during game play or driving simulation.

### SUMMARY OF THE INVENTION

In one aspect of the present invention, a mounting station for a video game controller includes at least one support bar having a substantially horizontal mid-section that extends laterally between a left and a right support arm. The left and the right support arm having a forwardly and downwardly extending first portion, a direction reversing intermediate portion, and an end portion that extends rearwardly from the direction reversing intermediate portion. The end portions are configured to be supported by a seating surface occupied by an operator of the video game controller. A mounting plate is attached to the mid-section of the support bar and is configured for attachment of the video game controller. The left and the right support arms may be laterally spaced apart such that an operator may be seated between the end portions of the left and the right support arms.

A seat base may be attached between the end portions of the left and the right support arm. The mounting plate is elevated from the seat base such that when the controller is carried by the mounting plate, the controller is positioned in an ergonomic orientation in front of the operator when the operator is sitting upon the seat base. Alternatively, the mounting plate is elevated from the seat base, such that when the controller is carried by the mounting plate, the controller is positioned in an ergonomic orientation in front of the operator when the operator is seated upon a furniture cushion interposed between the seat base and the operator.

In other aspects of the invention, a tilt mechanism is operatively coupled to the mounting plate. The tilt mechanism may include a base portion; a controller attachment plate; and a pivot attachment between the base portion and the controller attachment plate. The controller attachment plate is pivotally disposed about a lateral axis of the mounting station. The pivot attachment may also include a pivot arm, such that the controller attachment plate is pivotally disposed about an arc of rotation. The mounting station may also include a game controller operatively coupled to the mounting plate. The game controller may include a steering wheel control.

These and other features, aspects and advantages of the present invention will become better understood with reference to the following drawings, description and claims.

### BRIEF DESCRIPTION OF THE DRAWINGS

FIG. 1 is a perspective view of the station for a driver's video game controller shown in use;

FIG. 2 is a perspective view of the controller station;

FIG. 3 is an exploded view of the controller station;

FIG. 4 is a section view of the invention taken from 4-4 in FIG. 1;

FIG. 5 is a section view of an alternate embodiment of the mounting station;

FIG. 6 is an enlarged section view illustrating extension supports; and

FIG. 7 is a side view of an alternate embodiment illustrating a tilting mechanism.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an improved controller station for a steering wheel controller for a video game. The controller station provides a mount for securement of the controller that is configured for utilization with conventional seating furnishings within a home.

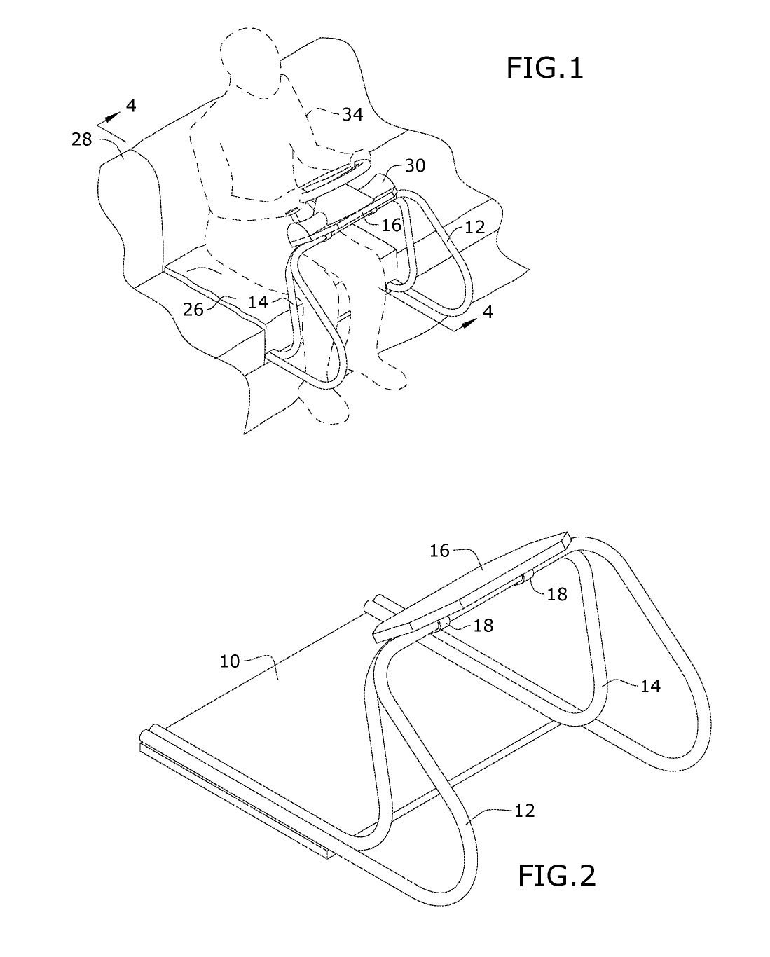

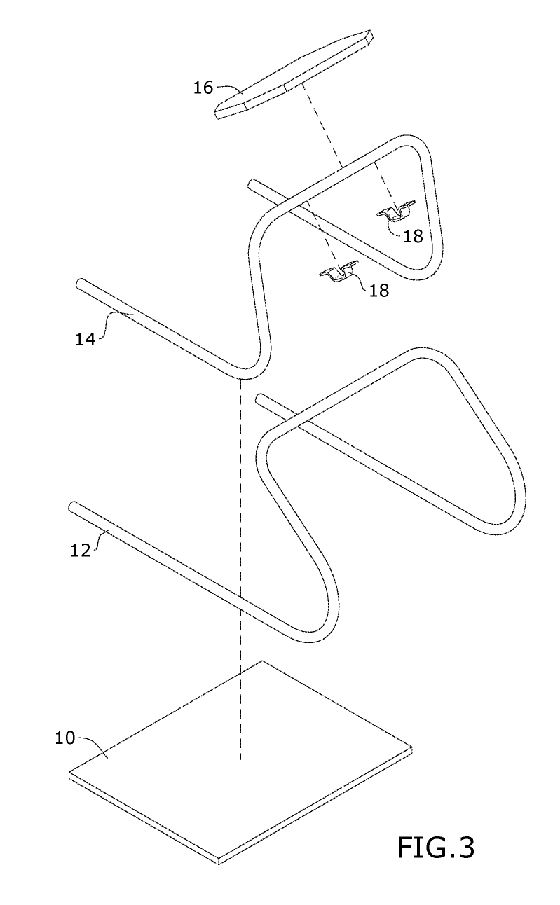

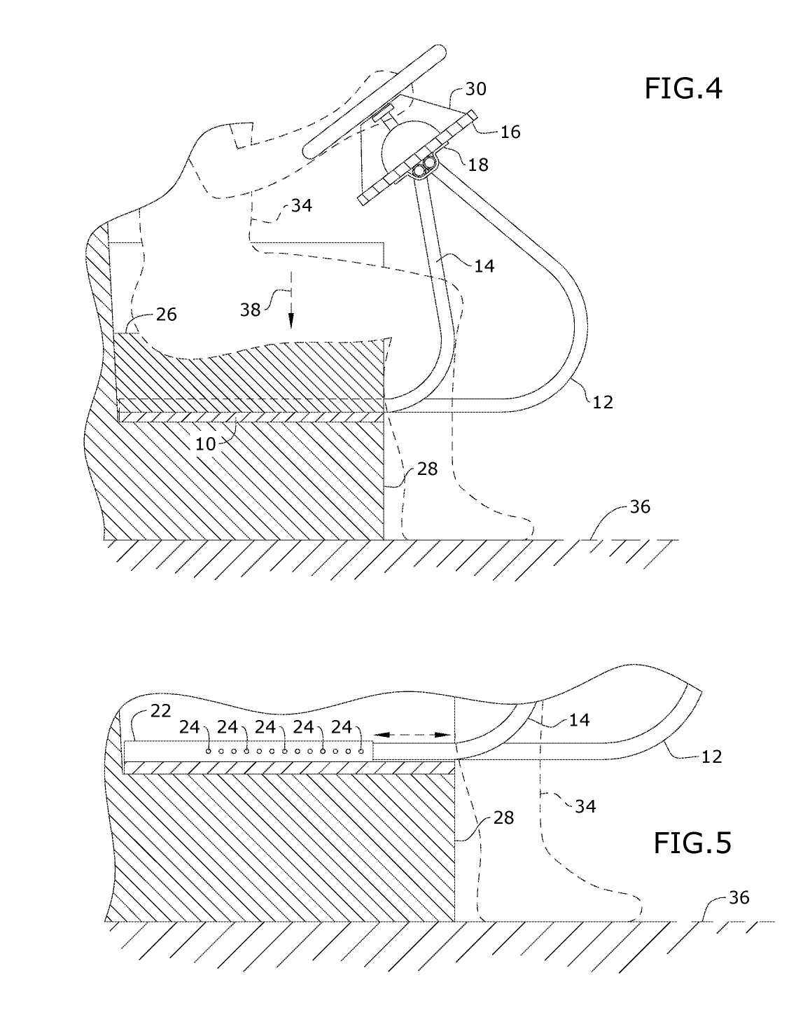

As seen in reference to FIGS. 1-4, a mounting station for a video game controller, may include a seat base 10 that is attached between an end portion 20 of at least one support bar 12, 14. The support bar 12, 14 has a substantially horizontal mid-section that extends laterally between a left and a right support arm. The left and the right support arm have a forwardly and downwardly extending first portion, a direction reversing intermediate portion, and an end portion 20 that extends rearwardly from the direction reversing intermediate portion.

The left and the right support arms are laterally spaced apart such that an operator 34 may be seated between the end portion of the left and the right support arms. The end portions 22 are configured to be supported by a seating surface occupied by an operator 34 of the video game controller 30.

The mounting plate 16 is elevated from the seat base such that when the controller 30 is carried by the mounting plate 16, the controller 30 is positioned in an ergonomic orientation in front of the operator 34 when the operator 34 is sitting upon the seat base 10. The seating surface may be a floor surface. More preferably, the seating surface may be a home furnishing 28, such as a couch or a recliner having a seat supporting surface and a cushion 26 that an operator 34 of the video game controller may sit upon while playing a video game.

As best seen in reference to FIGS. 5 and 6, the end portion 22 may be adjustable in length to adapt the mounting station to variously sized seating surfaces. The end portion 22 may have a plurality of apertures 24 disposed in a spaced apart relation along the end portion 22. An extension 20 that is received within the end portion 20. The extension 20 may include a retractable pin 25 that cooperatively engages with one of the plurality of apertures 24 to retain the extension 20 in a fixed position relative to the end portion 20.

A mounting plate 16 is attached to the mid-section of the support bar 12, 14 via an attachment 18, such as a bracket and screws. The mounting plate is 16 attached to the support bar so that it held in a fixed relationship relative to the support bar. The mounting plate 16 is configured for attachment of the video game controller 30. By way of non-limiting example, the attachment may include clamps that are carried by the video game controller 30. The attachment may also include a fastener, such as hook and pile fasteners that cooperatively engage to secure the controller 30 to the mounting plate 16. The attachment may also include pins, screws, or an adhesive.

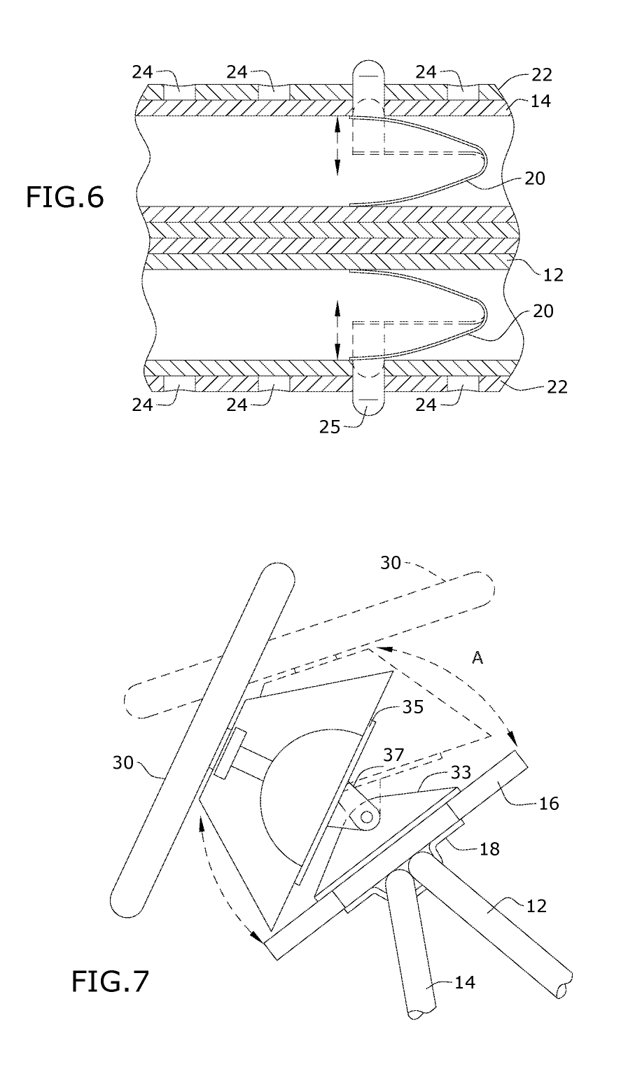

In some embodiments, such as shown in reference to FIG. 7, the controller mounting station may also include a tilt mechanism 32 that operatively coupled to the mounting plate 16. The tilt mechanism 32 includes a base portion 33, a controller attachment plate 35; and a pivot attachment between the base portion 33 and the controller attachment plate 35 such that the controller attachment plate 35 is pivotally disposed about a lateral axis of the mounting station. The tilt mechanism 32 may also include a pivot arm 37 such that the controller attachment plate 35 is pivotally disposed about an arc of rotation A.

It should be understood, of course, that the foregoing relates to exemplary embodiments of the invention and that modifications may be made without departing from the spirit and scope of the invention as set forth in the following claims.

What is claimed is:

1. A mounting station for a video game controller, comprising:
at least one support bar having a substantially horizontal mid-section extending laterally between a left and a right support arm, the left and the right support arm having a forwardly and downwardly extending first portion, a direction reversing intermediate portion, and an end portion extending rearwardly from the direction reversing intermediate portion, wherein the end portions are configured to be supported by a seating surface occupied by an operator of the video game controller; and
a mounting plate attached to the mid-section of the support bar and configured for attachment of the video game controller.

2. The mounting station of claim 1, further comprising:
a seat base attached between the end portions of the left and the right support arm.

3. The mounting station of claim 2, wherein the mounting plate is elevated from the seat base such that when the controller is carried by the mounting plate, the controller is positioned in an ergonomic orientation in front of the operator when the operator is sitting upon the seat base.

4. The mounting station of claim 2, wherein the mounting plate is elevated from the seat base, such that when the controller is carried by the mounting plate, the controller is positioned in an ergonomic orientation in front of the operator when the operator is seated upon a furniture cushion interposed between the seat base and the operator.

5. The mounting station of claim 1, further comprising:
a tilt mechanism operatively coupled to the mounting plate; comprising
a base portion; and
a controller attachment plate; and
a pivot attachment between the base portion and the controller attachment plate, wherein the controller attachment plate is pivotally disposed about a lateral axis of the mounting station.

6. The mounting station of claim 5, the pivot attachment further comprising:
a pivot arm, wherein the controller attachment plate is pivotally disposed about an arc of rotation.

7. The mounting station of claim 1, further comprising:
a game controller operatively coupled to the mounting plate.

8. The mounting station of claim 7, wherein the game controller comprises a steering wheel control.

9. The mounting station of claim 5, further comprising:
a game controller operatively coupled to the controller attachment plate.

10. The mounting station of claim 9, wherein the game controller comprises a steering wheel control.

11. The mounting station of claim 1, wherein the left and the right support arms are laterally spaced apart such that an operator may be seated between the end portion of the left and the right support arms.
